(19) United States
(12) Patent Application Publication
(10) Pub. No.: US 2013/0262457 A1
(43) Pub. Date: Oct. 3, 2013

(54) LOCATION NAME SUGGESTION

(71) Applicants: Defu Lian, Beijing (CN); Xing Xie, Beijing (CN)

(72) Inventors: Defu Lian, Beijing (CN); Xing Xie, Beijing (CN)

(73) Assignee: MICROSOFT CORPORATION, Redmond, WA (US)

(21) Appl. No.: 13/434,484

(22) Filed: Mar. 29, 2012

(51) Int. Cl. G06F 17/30

(52) U.S. Cl. 707/724; 707/758; 707/E17.014

(57) ABSTRACT

Some implementations provide techniques and arrangements to generate a ranked set of possible locations of a user based on user information and a user location. Some examples may generate a first set of locations that are near a location associated with the user. Features may be extracted from information about the user and the first set of locations for use by a ranking model. A second set of locations may be generated by the ranking model based on the extracted features and the first set of locations. In some cases, the second set of locations may be a ranked set of one or more of the locations of the first set of locations.

### BACKGROUND

Services have been established that facilitate location based social interaction. These services provide may provide a location sharing functionality that allows users to input and share their location with other users, such as a group of users designated as friends. In general, a user who wishes to share the user's location will use a program operating on a mobile device of the user. The user executes the program and selects a check-in-function. Some services use the user's detected position, such as a position detected by a Global Positioning System (GPS) functionality of the user's device, to provide a list of nearby locations from which the user can choose a location at which to check-in. However, in some situations, the precision of the user's detected position may be low, such as on the order of a position within one hundred to two hundred meters. In densely developed urban areas, there can be over one hundred points of interest (POIs, i.e., locations) within a hundred meter square. In such situations, the number of possible locations makes checking-in using the list of nearby locations inconvenient because the number of possible locations returned to the user may be unmanageable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some implementations provide techniques and arrangements to generate a ranked set of possible locations of a user based on user information and a user location. For example, for a first set of locations that are near a location associated with the user, features are extracted from information about the user and the first set of locations for use by a ranking model. A second set of locations may be generated by the ranking model based on the extracted features and the first set of locations, the second set of locations being a ranked set of one or more of the locations of the first set of locations.

### BRIEF DESCRIPTION OF THE DRAWINGS

The Detailed Description is described with reference to the accompanying figures. The use of the same reference numbers in different figures indicates similar or identical items.

FIG. 1 illustrates an example system according to some implementations.

FIG. 2 illustrates an example process flow according to some implementations.

FIG. 3 illustrates an example framework according to some implementations.

FIG. 4 illustrates an example process flow according to some implementations.

FIG. 5 illustrates select components of an example logic block diagram according to some implementations.

FIG. 6 illustrates select components of an example logic block diagram according to some implementations.

FIG. 7 illustrates an example system in which some implementations may operate.

### DETAIL DESCRIPTION

### Overview

This disclosure includes techniques and arrangements for location naming. In some implementations, the system uses user information in addition to a user's geo-position to provide a list of location names. User information can include various items such as a user's check-in history, information derived from the user's check-in history, preferences set by the user, and any other information about the user which may be useful in naming locations. Information derived from a user's check-in history can include information such as the frequency at which or a number of times a user has checked into a type or category of location, such as different types or categories of restaurants. Some implementations may use other and/or additional information to provide the list of location names, such as temporal information (e.g. time of day), indications of the popularity of the locations, events, and other contextual information.

Although location naming techniques are describe herein in the context of a social networking system, implementations are not so limited. For example, the techniques and arrangements could also be used in a system in which a user wished to keep a record of the user's own movements for personal and private use. Furthermore, even in the context of a social networking system, users may want to control aspects of what information is available regarding their location. Such implementations might allow a user to select varying levels of sharing for different groups of users or allow a user to establish rules about what types of location names are shared. Further, some implementations, whether or not in the social networking context, may require a user to consent to the use and/or collection of user data including location and history. Such implementations could require that the user opt-in, i.e. the user has to take an affirmative action before the data is collected, or that the user opt-out, i.e. the user can take an affirmative action to prevent the collection of data before that data is collected.

It should be noted that, for readability, interactions between modules are described herein as signals or communications, but it would be understood by one of ordinary skill in the art that such interactions may be implemented in various ways, such as by function calls between various program modules.

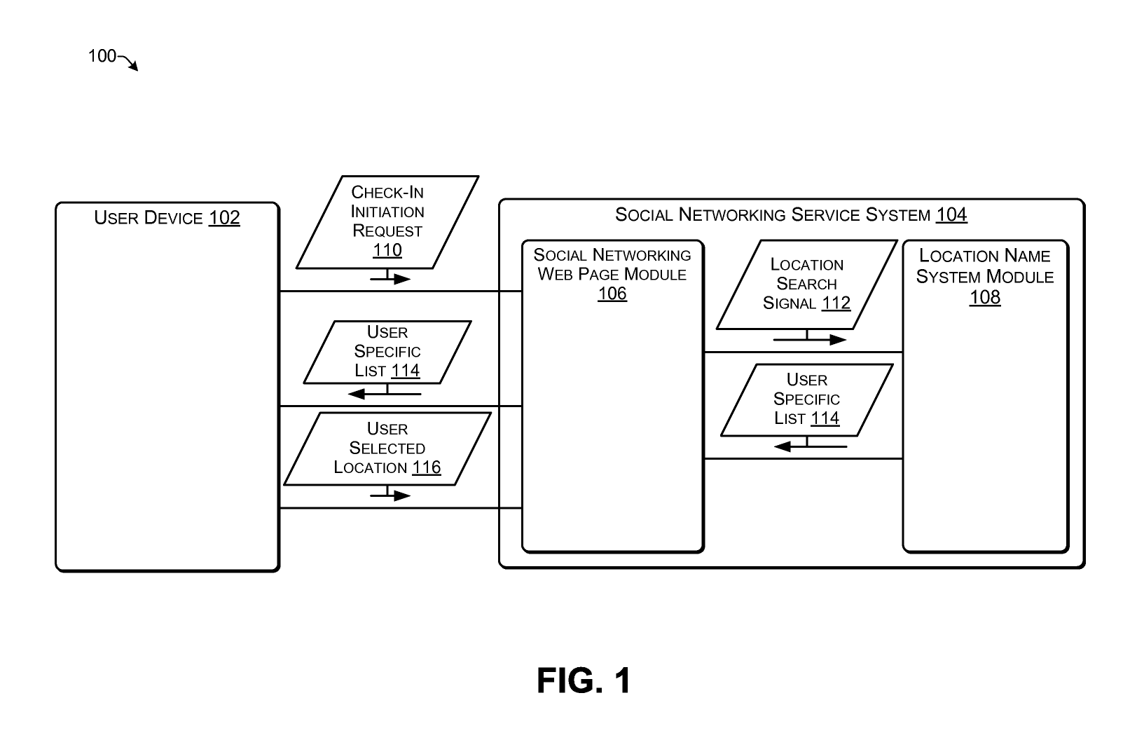

FIG. 1 illustrates an example framework of a system 100 according to some implementations. System 100 includes a user device 102 and a social networking service system 104. The social networking service system 104 is illustrated as a logical system made up of includes a social networking web page module 106 and a location name system module 108. The social networking web page module 106 provides for access to a web page for location-based social networking. For example, each user of the social networking service system 104 may interact with the social networking web page module 106 using a check-in functionality to record the user's current location. The user's location can then be shared with other users, such as users designated as friends of the user that is checked-in. During the check-in process, the social networking web page module 106 interacts with the location name system module 108 to obtain a user specific list of location names that is presented to the user for selection of a check-in location. While the social networking service system 104 is illustrated as including two separate modules, implementations are not so limited and may be implemented as any number of modules. It should be noted that the logical arrangements illustrated herein may be implemented as several components of hardware each configured to perform one or more functions, may be implemented in software or firmware where one or more programs are used to perform the different functions, or may be a combination of hardware, firmware, and/or software. For purposes of discussion, the module described herein will be discussed as a set of software routines stored in a computer readable storage medium.

Also, for ease of discussion and comprehension, the following discussion will assume that the check-in requests sent from the user device 102 to the social networking service system 104 include a geo-position of the user (e.g. a set of GPS coordinates detected by a user's device or an approximate location ascertained based on a connection to a device with a known location, such as an access points of a cellular network or a Wi-Fi network). However, implementations are not so limited. For example, in some implementations, the geo-position of the user may be sent to the social networking service system 104 on a periodic basis or could be sent in response to additional communication from the social networking service system 104.

In operation, the user device 102 transmits a check-in initiation request 110 to the social networking web page module 106 to initiate the check-in process.

The social networking web page module 106 receives the check-in initiation request 110 and sends a location search signal 112 to the location name system module 108. In some implementations, the location search signal 112 includes identification of the user and the geo-position of the user. However, implementations are not so limited and, for example, in some implementations, the identification of the user and the geo-coordinates may be sent in follow up communications.

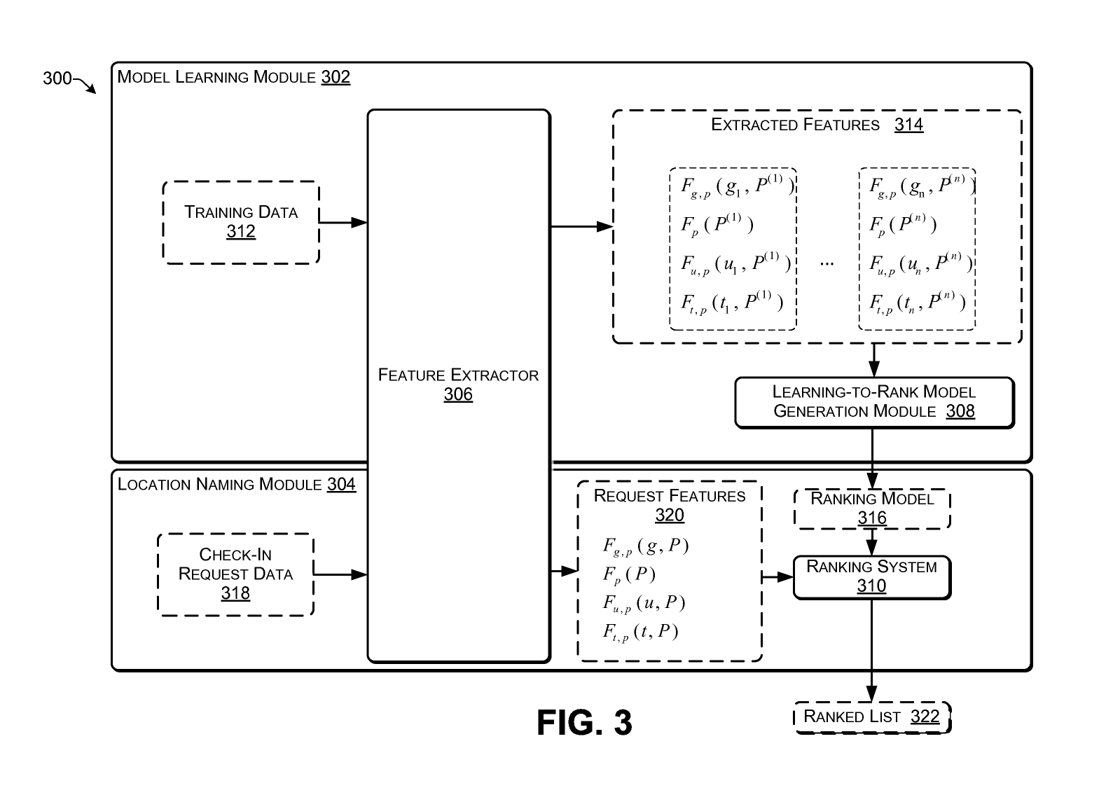

The location name system module 108 receives the location search signal 112 and generates a user specific list 114 of location names. In some implementations, the locations are selected for inclusion in the user specific list 114 based on the distance of the locations from the geo-position of the user and information about the user. The generation of the user specific list 114 of location names is discussed in the discussion of FIGS. 3-5. The location name system module 108 sends the user specific list 114 to the social networking web page module 106 which in turn forwards the user specific list 114 to the user device 102 in a reply to the check-in initiation request 110.

The user is then presented the user specific list 114 and selects one of the location names as the location which the user is to be checked in at. The user selected location 116 is then sent to the social networking web page module 106.

When the social networking web page module 106 receives the user selected location 116, the social networking web page module 106 uses the received user selected location name 116 in a manner appropriate for the specific implementation. For example, in the location sharing social networking context, the social networking web page module 106 updates the user location shared with the user's designated friends on a web page.

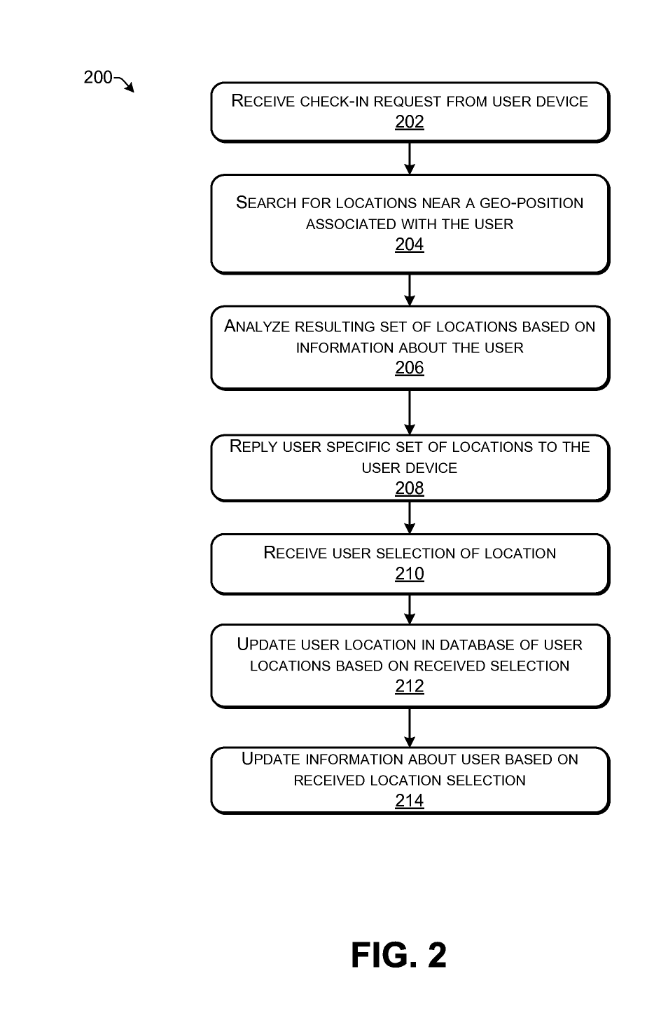

FIG. 2 illustrates an example process flow 200 according to some implementations in the context of location sharing social networking wherein the user information includes at least information about a user's check-in history. In some implementations, the user's check-in history may include, for each location the user has checked-in at, a number of times the user has checked in at that location.

At 202, a check-in initiation request is received from a user device that includes user identification and a geo-position associated with the user.

At 204, the system then searches a database of locations to generate a list of locations near the geo-position associated with the user. For example, the search may return all locations that are within a predetermined distance of the geo-position associated with the user.

At 206, the list of locations near the geo-position associated with the user is analyzed based on information about the user to generate a user specific list of locations. As discussed above, this analysis may be based on a user's check-in history or information derived based at least in part on the user's check-in history. For example, if the user's geo-position is found to be in close proximity to a plurality of locations but the plurality of locations includes only three locations which the user has previously checked-in at, these locations are “ranked” at the top of the list of user specific locations to be returned.

At 208, a reply is sent to the user device that includes the names of the locations in the generated user specific list of locations.

At 210, the system receives a selection by the user of one of the locations in the list of location names to be used as the user's check-in location.

At 212, the system updates the user's location in a database of user locations based on the received selection such that other users will be able to view the location at which the user has checked-in on the social networking web page.

At 214, the system updates information about the user based on the location at which the user has checked-in. Continuing the previous example, the system may update the user's check-in history to increment the number of times the user has checked in at the selected location or add a record for the selected location as necessary.

### Location Name Searching Framework

FIG. 3 illustrates an example framework 300 for location name searching. Framework 300 includes a model learning module 302 and a location naming module 304. Modules 302 and 304 share a feature extractor 306. The model learning module 302 also includes a learning-to-rank model generation module 308 and the location naming module 304 includes a ranking system 310. Although the feature extractor 306 is illustrated as a shared module in FIG. 3, implementations are not so limited and modules 302 and 304 may each include a dedicated feature extractor or the feature extractor may be a separate and independent module.

In operation, training data 312 is input to feature extractor 306 and features are extracted as extracted features 314. The extracted features 314 may include static features, such as features related to points of interest. For example, features representing the popularity of the POIs may be extracted from general websites, review websites, and location-based services. The extracted features 314 may also include dynamic features (e.g., features that vary from check-in to check-in or from user to user). For example, dynamic features may be extracted from an overall check-in history of the users of the system.

The extracted features 314 are used to create a model that generates a user specific list of location names in response to a check-in request. Specifically, the extracted features 314 are input into learning-to-rank model generation module 308 that uses a learning to rank techniques to create a ranking model 316 that can generate the user specific list. The ranking model 316 is provided to ranking system 310. While learning-to-rank techniques are used herein to create the ranking model 316, implementations are not limited to these techniques and the particular technique used to create the model 316 may vary between implementations.

When a user initiates a check-in process, check-in request data 318 is provided to the feature extractor 306 along with contextual information and the information about the locations to be searched. From the provided data, the feature extractor 306 generates request features 320.

The request features 320 are input to the ranking system 310 which uses the ranking model 316 to generate a ranked list 322 of locations which is sent to the user device for use by the user to check-in.

The following paragraphs provide a more formal description of some of the operations of the framework 300 illustrated in FIG. 3.

In the following discussion, a point of interest p is a specific point location, (e.g. a business, a residence, a park, etc.). The geo-position of the specific point location, p.loc, is generally described by latitude and longitude, and optionally altitude. A meaningful name, p.name, is attached to the point of interest p. A plurality of points of interest p are included in a POI database denoted P. A check-in record c is a quadruple (t, g, p, u) which indicates user c.u visited POI c.p at the particular time c.t, with the user c.u having a geo-position of c.g. For the purposes of discussion of FIG. 3, the geo-position of the user c.g is a GPS-device detected location. An additional item that may be included in the check-in record is c.dis which is the distance between the user's detected location c.g and the location of the point of interest c.p.loc. In operation, c.g is at least a part of the information submitted to the location naming system as a part of the query for searching nearby POIs. Also, in the following discussion, the user information used in location naming system includes at least check-in history information. In one context, a check-in history, denoted Cₜₛ^{te}, is a collection of check-in records of multiple users between start time tₛ and end time tₑ. In another context, for a given user u, user u's check-in history, denoted Cᵤ, is a subset of Cₜₛ^{te} and includes user u's past check-in records. In a third context, for a given POI p, POI p's check-in history, denoted Cₚ, is also a subset of Cₜₛ^{te} and includes the check in records of multiple users at POI p.

In view of the terminology set forth above, in the framework 300 described herein, the training data 312 from which extracted features 314 are extracted may include the check-in history Cₜₛ^{te} and a POI Database P. The extracted features 314 are input into the learning-to-rank model generation module 308 to create a ranking model 316 created using a “learning to rank” technique is used by ranking system 310.

When a user initiates a check-in, information from the check-in request (e.g. user identification (c.u) and user location (c.g)) and contextual information (e.g. time of the request (c.t)) together with each POI p in the POI database P are input to the feature extractors for extracting features. The extracted features are then input into the ranking model which returns a ranked list 322 of POIs. In other words, given the POI database P, a check-in history Cₜₛ^{te}, a user u, a time t (t>tₑ) and a GPS reading g, the location naming module 304 returns a ranked list 322 of the “most probable” location names, denoted R_{g,u,t,C}_{ₜₛ}_{^{te}}(P). It should be noted that in some implementations, rather than extracting features for each POI in POI database P during check-in, a subset of P could be used such as a subset including POIs within a certain distance of the user location g.

Implementations are not limited to the use of any particular feature and the features may include static features and/or dynamic features. In the implementations shown in FIG. 3, given a user u, a time t, and a GPS reading g, for each POI p, feature extractors extract at least four types of features: 1) the relationship between GPS reading g and POI p−F_{g,p}(g,p); 2) the popularity of p−Fₚ(p); 3) the relationship between user u and POI p−F_{u,p}(u,p); and 4) the relationship between time t and POI p−F_{t,p}(t,p). These types of features are discussed below.

In some implementations, features of the Fₚ (p) type are static and query-independent. These popularity features may be extracted from at least the following resources—web pages, review websites and location-based social networks. Taking location-based social networks as an example, when users use the location-based social networks, their actions are logged by the system to generate an overall check-in history Cₜₛ^{te}. These actions may represent the users' interest in the POIs and this can be extracted as an indication of the popularity of the POIs. In other words, it may be assumed that the POIs with more check-ins are more popular than those with less check-ins. This can be expressed at least in terms of the number of check-ins at p and/or the number of users who have checked-in at p. In some implementations, prior to extracting popularity features for POIs from an overall check-in history Cₜₛ^{te}, filtering may be performed on the check-in history Cₜₛ^{te} to filter out check-in records that are likely “fake” records. A fake record may be a record which does not represent a valid check-in of a user who actually visited the POI. A significant type of fake check-in record is created by a user checking-in at the same POI multiple times during a short period or at different POIs in a short time. Users have been known to make such fake check-ins at least for fun or for the sake of benefits from possible promotions. The large amounts of check-in records produced by these users can reduce the efficacy of the ranking model by skewing the training data used to create the model. Such fake records can be addressed in at least two ways. First, the system can attempt to detect and remove individual records which are determined to be fake. Second, if a user is determined to likely be creating fake check-in records, such as by exceeding a threshold number of check-ins per day, the check-in records of that user could be ignored when creating the ranking model.

Features of the F_{g,p}(g,p) type can include features such as the distance from g to p.loc. In implementations that use the latitude and longitude to represent geo-coordinates of POIs and GPS readings, the distance could be computed as the spherical distance between g and p.loc. Alternatively, implementations could also compute other measures such as the driving distance or walking distance between g and p.loc.

Features of the F_{t,p}(t,p) type provide temporal information. Temporal information may be good evidence for inferring where users are located. For example, a fast food restaurant is a more likely location on weekdays than on weekends because of users' greater interest in saving time on weekdays. In some implementations, t may be measured at different levels of granularity. For example, in some implementations, t may be quantized into discrete values with three types of granularities: a day of the week; a binary indicator for weekend or weekday; and a time in a day which is quantized into four-hour windows.

Features of the F_{u,p}(u, p) type indicate u's preference toward POI p. The higher the evidence is, the more preferable POI p is to u. In other words, this type of feature may be considered to represent how popular p is in the opinion of u. An example of this type of feature is the number of times user u has checked-in at p or at POIs that are similar to p. The former can be computed based on u′s check in history Cᵤ and is formulized as follow: given check-in history Cᵤ, F_{u,p}(u,p)=|{c∈Cᵤ|c.p=p}|.

Implementations are not limited to the above described features. Another type of feature is events. Events can influence user activities and thus have an impact on their most probable location. Weather is one type of event that may be a good indicator of a user's location. Thus, weather could be included in the features that are input into the learning-to-rank algorithm to allow for the popularity of POIs in different kinds of weather conditions to be accounted for in the ranking model 316. Another type of event that can be used as a feature is the opening of a store or a sale on merchandise advertised by a store. These events can also increase or decrease popularity of nearby POIs. Other types of features that could be used may include the features that represent the relationship between a combination of two or more of t, g, and u with the POI p, features that represent the relationship of a group of users that are similar to u with the POI p, and features that represent categories. An example of the latter type of feature would be a feature that indicates a user u's preference for a category of location (e.g. a type of restaurant) and could be measured by the number of times the user u has checked in at that category of location.

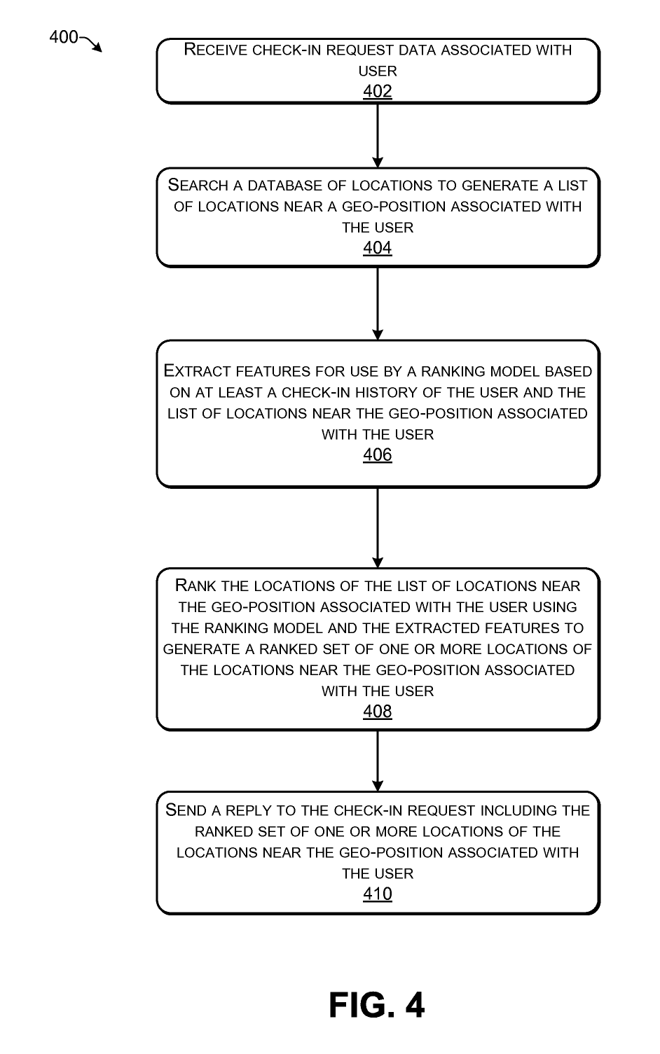

FIG. 4 illustrates an example process flow 400 according to some implementations of a location naming module wherein the check-in request data includes at least a user identification associated with to a user check-in history. In some implementations, the user's check-in history may include, for each location the user has checked-in at, a number of times the user has checked in at that location.

At 402, check-in request data is received that is associated with a user and that includes at least a user identification and a geo-position of the user.

At 404, the geo-position in the check-in request data is used to search a database of locations to generate a list of locations near the geo-position associated with the user.

At 406, the check-in request data and the list of locations near the geo-position associated with the user are provided to a feature extractor. The feature extractor extracts features for use by a ranking model based on at least the check-in history of the user and the list of locations near the geo-position associated with the user.

At 408, the extracted features and the list of locations near the geo-position associated with the user are received by a ranking system. The ranking system then ranks the locations of the list of locations near the geo-position associated with the user using the ranking model and the extracted features to generate a ranked set of one or more locations of the locations near the geo-position associated with the user.

At 410, a reply to the check-in request is sent that includes the ranked set of one or more locations of the locations near the geo-position associated with the user.

### Example Implementations of the Location Name System Module

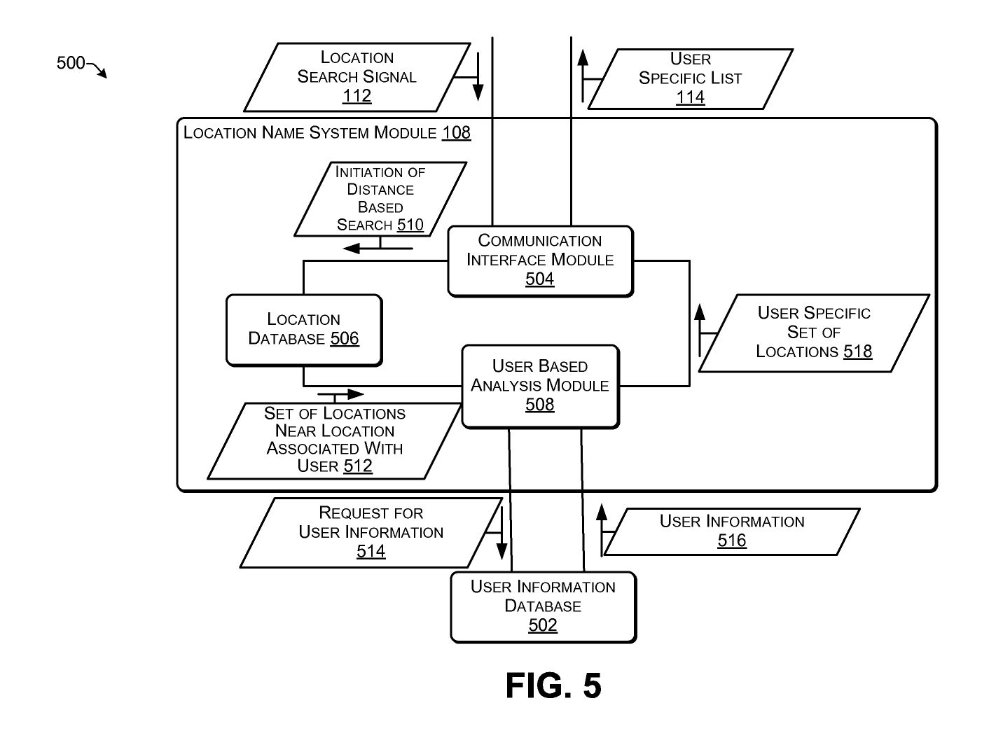

FIG. 5 illustrates a block diagram of an example logical arrangement 500 including the location name system 108 and a user information database 502. The location name system module 108 includes a communication interface module 504, a location database 506, and a user based analysis module 508.

In operation, the communication interface module 504 receives the location search signal 112 from the social networking web page module 106. In response to signal 112, the communication interface module 504 sends the initiation of a distance based search signal 510 to the location database 506.

Upon receiving the distance based search initiation signal 510, the location database 506 searches a database of locations to generate a list of locations within a predetermined distance of the geo-position associated with the user 512. The location database 506 sends the list of locations within a predetermined distance of the geo-position associated with the user 512 to the user based analysis module 508.

Upon receiving the list of locations 512 from the location database 506, the user based analysis module 508 sends a request for user information 514 to the user information database 502 and receives user information 516 in response. The user based analysis module 508 then analyzes the list of locations near the geo-position associated with the user 512 based on the user information 516 to generate a user specific set of locations 518. For example, the user based analysis module 508 may generate the user specific set of locations 518 using a ranking model created in the manner discussed above with regard to FIG. 3. The user specific set of locations 518 is sent to the communication interface module 504 which forwards the user specific set of locations 518 to the social networking web page module 106 as user specific list 114.

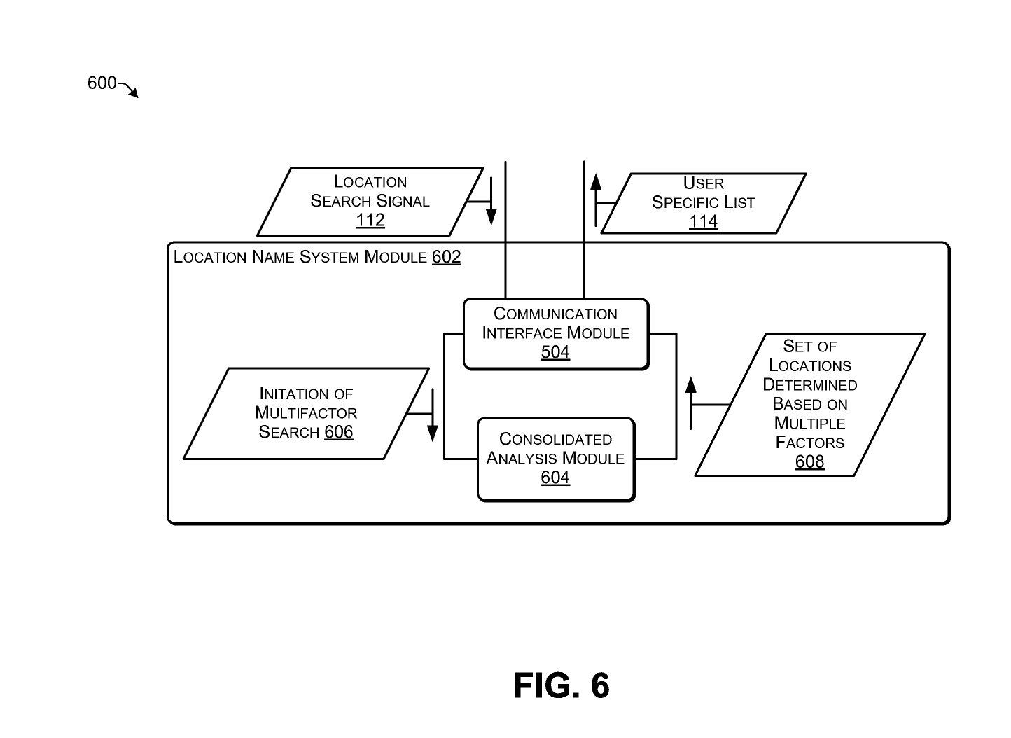

FIG. 6 illustrates a block diagram of another example logical arrangement 600 including the location name system module 602 which generates the user specific list 114 of locations based on multiple factors (e.g. multiple features discussed above with respect to FIG. 3). The location name system module 602 includes the communication interface module 504 and a consolidated analysis module 604.

In operation, the communication interface module 504 receives the location search signal 112 from the social networking web page module 106. In response to signal 112, the communication interface module 504 sends an initiation of multifactor search signal 606 to the consolidated analysis module 604.

Upon receiving initiation signal 606, the consolidated analysis module 604 performs a multifactor analysis to generate a user specific set of locations determined based on multiple factors 608. The multifactor analysis may include various factors such as distance, user information, popularity of the locations and can be performed using a ranking model created in the manner discussed above with respect to FIG. 3. Further, the multifactor analysis may be implemented as a single step process or as a multistep process. For example, some implementations may include a first step of the analysis could perform a preliminary search to find locations that are within a predetermined distance of the user and a second step that uses the ranking model to determine the most probable locations within the predetermined distance. The user specific set of locations determined based on multiple factors 608 is sent to the communication interface module 504 which then forwards the user specific set of locations determined based on multiple factors 608 to the social networking web page module 106 as user specific list 114.

### Example Computing Device and Environment

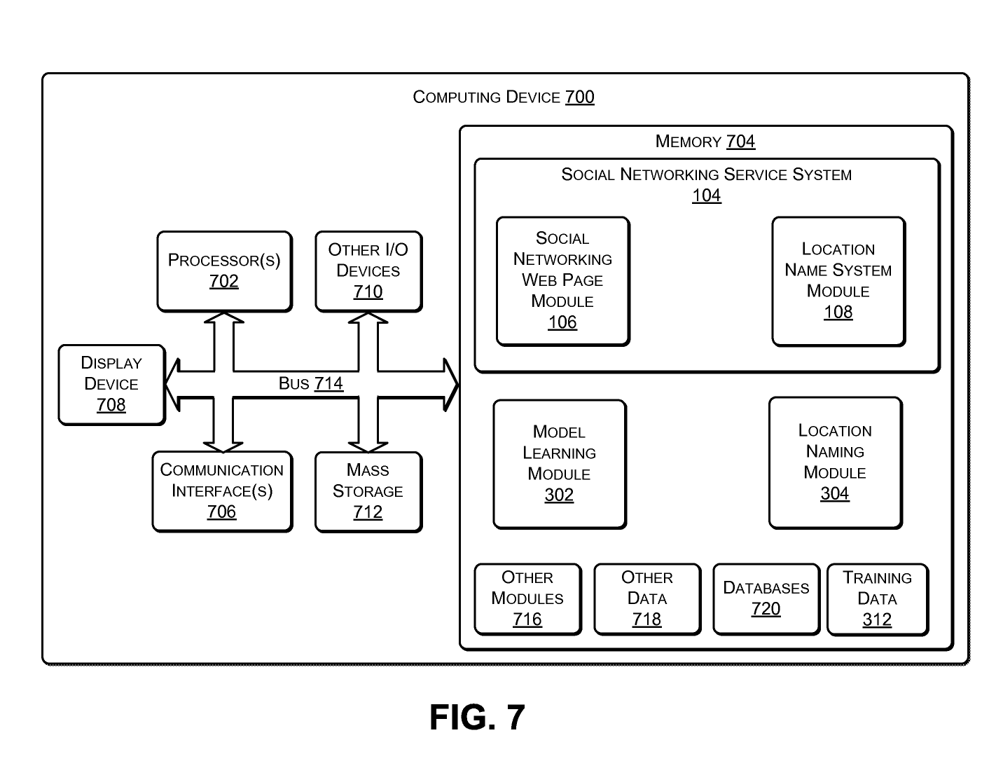

FIG. 7 illustrates an example configuration of a computing device 700 and environment that can be used to implement the modules and functions described herein. The computing device 700 may include at least one processor 702, a memory 704, communication interfaces 706, a display device 708, other input/output (I/O) devices 710, and one or more mass storage devices 712, able to communicate with each other, such as via a system bus 714 or other suitable connection.

The processor 702 may be a single processing unit or a number of processing units, all of which may include single or multiple computing units or multiple cores. The processor 702 can be implemented as one or more microprocessors, microcomputers, microcontrollers, digital signal processors, central processing units, state machines, logic circuitries, and/or any devices that manipulate signals based on operational instructions. Among other capabilities, the processor 702 can be configured to fetch and execute computer-readable instructions stored in the memory 704, mass storage devices 712, or other computer-readable media.

Memory 704 and mass storage devices 712 are examples of computer storage media for storing instructions which are executed by the processor 702 to perform the various functions described above. For example, memory 704 may generally include both volatile memory and non-volatile memory (e.g., RAM, ROM, or the like). Further, mass storage devices 712 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 704 and mass storage devices 712 may be collectively referred to as memory or computer storage media herein, and may be a non-transitory media capable of storing computer-readable, processor-executable program instructions as computer program code that can be executed by the processor 702 as a particular machine configured for carrying out the operations and functions described in the implementations herein.

The computing device 700 may also include one or more communication interfaces 706 for exchanging data with other devices, such as via a network, direct connection, or the like, as discussed above. The communication interfaces 706 can facilitate communications within a wide variety of networks and protocol types, including wired networks (e.g., LAN, cable, etc.) and wireless networks (e.g., WLAN, cellular, satellite, etc.), the Internet and the like. Communication interfaces 706 can also provide communication with external storage (not shown), such as in a storage array, network attached storage, storage area network, or the like.

A display device 708, such as a monitor may be included in some implementations for displaying information to users. Other I/O devices 710 may be devices that receive various inputs from a user and provide various outputs to the user, and may include a keyboard, a remote controller, a mouse, a pen, a voice input device, a touch input device, a printer, audio input/output devices, and so forth.

Memory 704 may include modules and components for the social networking service system 104 according to the implementations herein. In the illustrated example, memory 704 includes the social networking service system 104 described above that affords functionality for a social networking web page with the location naming functionality described herein. For example, as discussed above, social networking service system 104 may include the social networking web page module 106 and the location name system module 108. The memory 704 also includes the model learning module 302 and a location naming module 304. Memory 704 may further include one or more other modules 716, such as an operating system, drivers, communication software, or the like. Memory 704 may also include other data 718, such as data stored while performing the functions described above and data used by the other modules 716. Memory 704 may also include other data and data structures described or alluded to herein. For example, memory 704 may include training data 312 for use in creating a ranking model using a learning-to-rank algorithm as described above and one or more databases 720, which may include the user information, point of interest information, and/or other information used by a ranking model to generate a list of location names as described above.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although illustrated in FIG. 7 as being stored in memory 704 of computing device 700, social networking service system 104, or portions thereof, may be implemented using any form of computer-readable media that is accessible by computing device 700. As used herein, “computer-readable media” includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A computer-implemented method comprising:
receiving a check-in initiation request associated with a user;
searching a database of locations to generate a first set of locations that are near a location associated with the user;
extracting features for use by a ranking model created using a learning-to-rank algorithm from at least information about the user and the first set of locations, the user information including at least a check-in history of the user;
ranking the first set of locations using the ranking model and the extracted features to generate a second set of locations, the second set of locations being a ranked set of one or more locations of the first set of locations; and
transmitting a reply to the check-in initiation request, the reply including at least the names of the locations of the second set of locations.

2. The computer-implemented method of claim 1, further comprising:
receiving a selection of one of the locations of the second set of locations from the user; and
setting a user location of the user in a database of user locations to the selected location.

3. The computer-implemented method of claim 2, further comprising:
receiving a request for the location of the user;
retrieving the location of the user from the database of user locations; and
replying to the request for the location of the user with the retrieved location of the user.

4. One or more computer storage media encoded with instructions that, when executed by one or more processors cause the one or more processors to perform acts comprising:
searching a database of locations to generate a first set of locations that are near a location of a user; and
analyzing the first set of locations based at least in part on information about the user to generate a second set of locations.

5. The one or more computer storage media of claim 4, wherein the information about the user includes a check-in history of the user.

6. The one or more computer storage media of claim 4, wherein the analyzing is further based, at least in part, on popularity information of the locations of the first set of locations.

7. The one or more computer storage media of claim 4, wherein the analyzing is further based, at least in part, on temporal information.

8. The one or more computer storage media of claim 4, wherein the analyzing is further based, at least in part, on a preference of the user for types of locations.

9. The one or more computer storage media of claim 4, wherein the information about the user includes information derived from a check-in history of the user.

10. The one or more computer storage media of claim 4, wherein the analyzing comprises:
extracting features for input to a ranking model created using a learning-to-rank algorithm from the information about the user and the first set of locations; and
inputting the extracted features into the ranking model to generate the second set of locations, the second set of locations being a ranked set of one or more locations of the first set of locations.

11. The one or more computer storage media of claim 10, wherein the extracting is further based, at least in part, on popularity information of the locations of the first set of locations and contextual information.

12. The one or more computer storage media of claim 11, wherein:
the searching is initiated in response to a received request for a ranked set of locations for use by the user during a check-in process;
the contextual information includes at least the time the request was received; and
the acts further comprise transmitting a reply to the request for the ranked set of locations, the reply including at least the names of the locations of the second set of locations.

13. The one or more computer storage media of claim 11, the acts further comprising:
updating the information about the user based, at least in part, on a selection received from the user of one of the locations of the second set of locations.

14. A social networking system comprising:
one or more processors;
one or more computer storage media storing instructions that, when executed by the one or more processors, cause the one or more processors to perform acts comprising:
in response to a received request for a ranked set of locations for use by a user during a check-in process, analyzing a first set of locations based at least in part on information about the user and a location of the user to generate a second set of locations; and
transmitting a reply to the request for the ranked set of locations, the reply including at least names of the locations of the second set of locations.

15. The system of claim 14, wherein the analyzing comprises:
extracting features for use by a ranking model created using a learning-to-rank algorithm from the information about the user and the first set of locations; and
inputting the extracted features into the ranking model to generate the second set of locations, the second set of locations being a ranked set of one or more locations of the first set of locations.

16. The system of claim 14, wherein the information about the user includes at least a check-in history of the user.

17. The system of claim 14, wherein the analyzing is further based, at least in part, on at least one of: popularity information of the locations of the first set of locations and contextual information of the received request.

18. The system of claim 14, wherein the information about the user includes information derived from a check-in history of the user.

19. The system of claim 14, the acts further comprising:
updating the information about the user based, at least in part, on a selection received from the user of one of the locations of the second set of locations.

20. The system of claim 14, the acts further comprising:
updating the location of the user displayed on a web page based, at least in part, on a selection received from the user of one of the locations of the second set of locations.
